(19) United States
(12) Patent Application Publication
(10) Pub. No.: US 2018/0124034 A1
(43) Pub. Date: May 3, 2018

(54) IMAGE BASED METHOD, SYSTEM AND COMPUTER PROGRAM PRODUCT TO AUTHENTICATE USER IDENTITY

(71) Applicant: James Gregory Duvall, HOUSTON, TX (US)

(72) Inventor: James Gregory Duvall, HOUSTON, TX (US)

(21) Appl. No.: 15/338,356

(22) Filed: Oct. 29, 2016

(51) Int. Cl. H04L 29/06

(52) U.S. Cl. CPC H04L 63/083; H04L 63/1441

(57) ABSTRACT

An authentication process is disclosed which authenticates a user identity with a password that includes at least one portion based on an image that is saved on the user's local device. The password generated may be based on the user selected image and the process may use the image in calculating a hash function for the password. In some embodiments, only parts of the user selected image are used to generate the hash. In addition, more than one user selected image may be used for the password. In some embodiments, the password may include both image based elements and alphanumeric elements in calculating the hash value.

### BACKGROUND

The embodiments herein relate generally to security systems, and more particularly, to an image based method, system and computer program product to authenticate user identity.

Current password techniques for authentication are too susceptible to breaking or being hacked. Conventional passwords comprise simple keyboard characters. There exist many tools for cyber thieves to use that compromise a stored password, guess at the password based on popular password choices, or simply automate entry of simple characters in various possible combinations until the correct password is reached. Some passwords are stored locally on the user's computer and malware that sneaks through background processes into files or tracks keyboard entry can record passwords leaving the account susceptible.

Some systems now use objects displayed on a screen to represent a password. The objects are generated by a remote host server. A site using passwords based on on-screen object selection still relies on GUI commands to enter the object selection which remains susceptible to being tracked by malware.

As can be seen, there is a need for a password authentication system that circumvents automated password hacking tools and malware tracking tools.

### SUMMARY

In an exemplary embodiment of the present invention, a computer program product for authenticating a user's identity through an electronic interface, comprises a non-transitory computer readable storage medium having computer readable program code embodied therewith. The computer readable program code is configured to: receive from a user entry into the electronic interface during a registration process, an image file selected by the user from a computing device storage module; analyze a portion(s) of the image file for byte values representing the portion(s); generate a hash value from the analyzed portion(s) of the image file, wherein the hash value represents at least a portion of a password; store the generated hash value in association with a user's password registration including the password; determine whether a user password input during a login process includes the stored generated hash value; and authenticate or deny the login process based on the user password input including the stored generated hash value.

In another exemplary embodiment, a server system comprises a processor configured to: receive from a user during a login process, a password entry into an electronic interface, the password entry including an image file selected by the user from a local computing device storage module; analyze the image file for byte values representing the image file; determine a login hash value from the analyzed image file, wherein the login hash value represents at least a portion of the password entry; retrieve from server storage, a stored hash value associated with a registered password provided by the user, the stored hash value based on an image file selected by the user during the registration process; determine whether the password entry including the login hash value during the login process matches the registered password retrieved from server storage; and authenticate or deny the login process based on the user password entry including the stored hash value based on the image file selected by the user during the registration process.

### BRIEF DESCRIPTION OF THE FIGURES

The detailed description of some embodiments of the invention is made below with reference to the accompanying figures, wherein like numerals represent corresponding parts of the figures.

FIG. 1 is a flowchart of a method for authenticating a user's identity through an electronic interface using a hash value of an image file according to an embodiment of the subject technology.

FIG. 2 is a flowchart of a process of analyzing an image file for generating a hash value according to an embodiment of the subject technology.

FIG. 3 is a screenshot of a user interface depicting a registration process and input of a password entry at least partially from an image file stored on a user's local computing device according to an embodiment of the subject technology.

FIG. 4 is a screenshot of a user interface depicting a source folder of an image file stored on a user's local computing device for use in a password entry during a login process according to an embodiment of the subject technology.

FIG. 5 is a block diagram of a computer system/server according to an embodiment of the subject technology.

### DETAILED DESCRIPTION OF CERTAIN EMBODIMENTS

In general, embodiments of the subject technology provide a process, a computer program product, and system for password authentication through electronic interfaces that uses an image file as part of the password. The image file may be transformed into a hash value. In some embodiments, only a section or parts of the image file are used to generate the hash value. The password field may include the hash representation of the image file stored on the user's computing device. One or more image files may be part of the password which may also include alphanumeric content. The image file related portions and the alphanumeric portions may be entered at any point in the password combination when created. The password with hash representations of the image file (and alphanumeric content when used) may be stored on a remote server. During login, the user may open a local file to select an image whose hash representation is to be entered into the password entry field. The system may generate a hash value for the image file during login password entry. The server may compare the password entry including hash value(s) during login with the password entry including hash value(s) stored from registration to authenticate the login process.

As may be appreciated, the embodiments disclosed provide a new dimension in password security. Known techniques for breaking password encryption may use machine processes to guess password combinations or sequentially enter all possible password combinations from an alphanumeric set until an authorized password is recognized. At a high level of authentication, hackers are presented a new barrier that requires access to a user's files for images which thwarts approaches that rely on pure alphanumeric sets that can be randomly or sequentially entered. Moreover, even if a cyber threat were able to steal image files from the user's storage, the process to hack the password is still protected by the embodiments disclosed because the threat would need access to the server side process for generating the hash value for an image.

As used herein, the phrase “image file” includes any digitally stored visual graphic which may include for example, a photograph, a digital painting, a video frame, an alphanumeric character, or a symbol. A “byte value” as used herein may include for example, a value assigned to a pixel of the image file which may be based on an attribute such as color, a coordinate in the frame of the image, or a previously assigned value as coded by software used to generate the image.

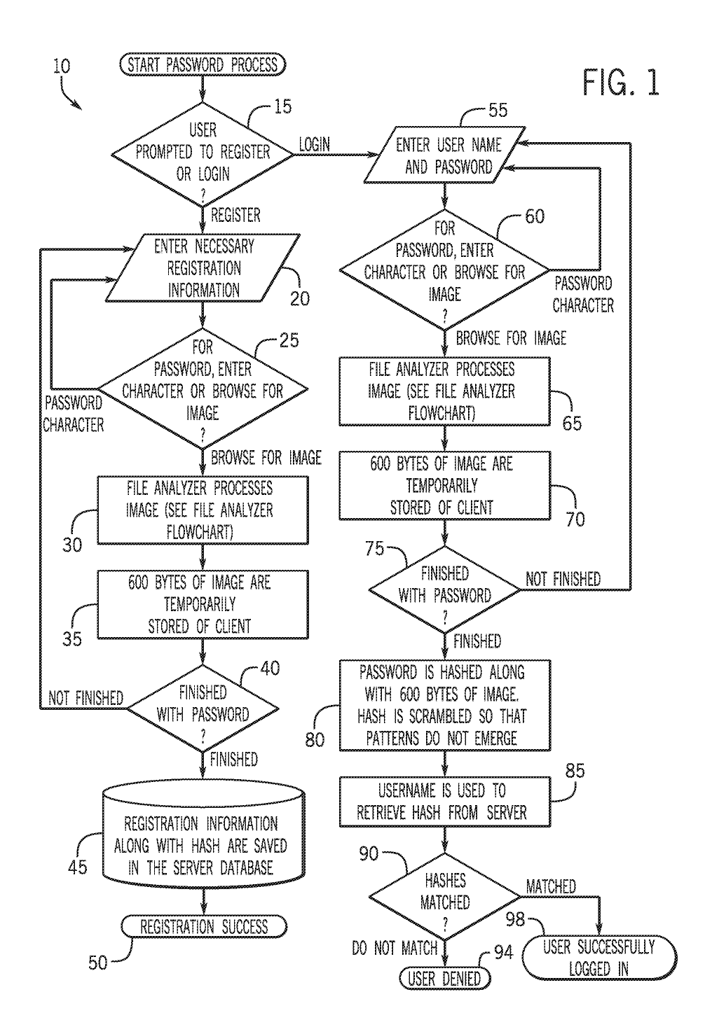

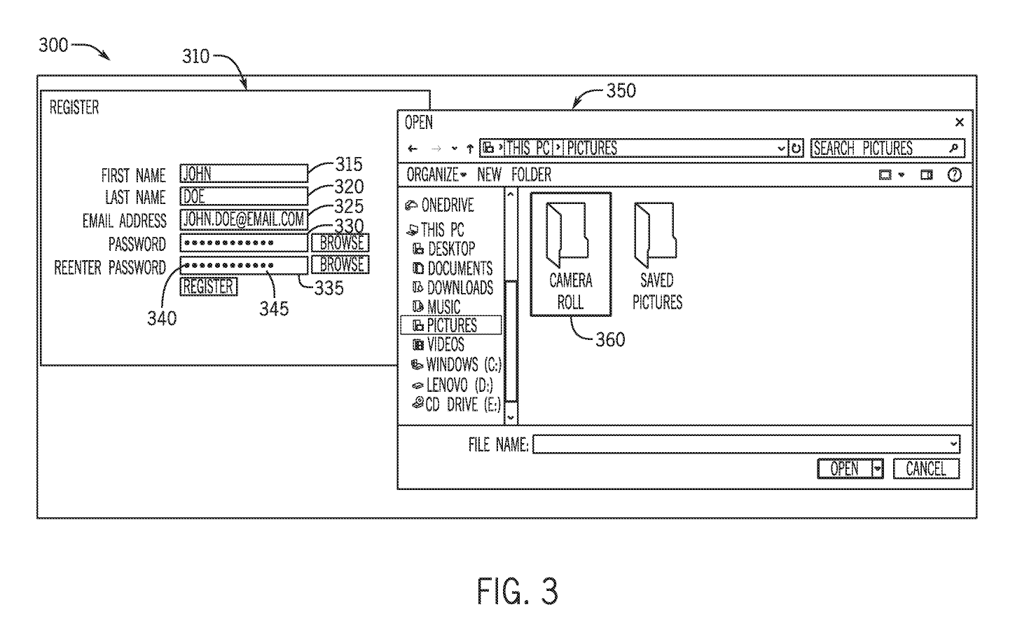

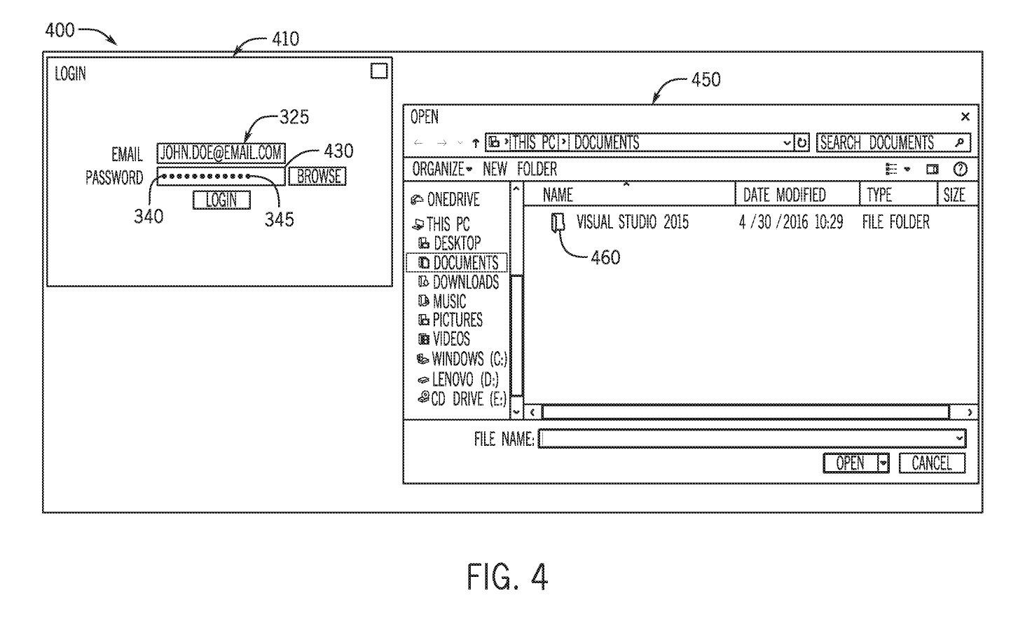

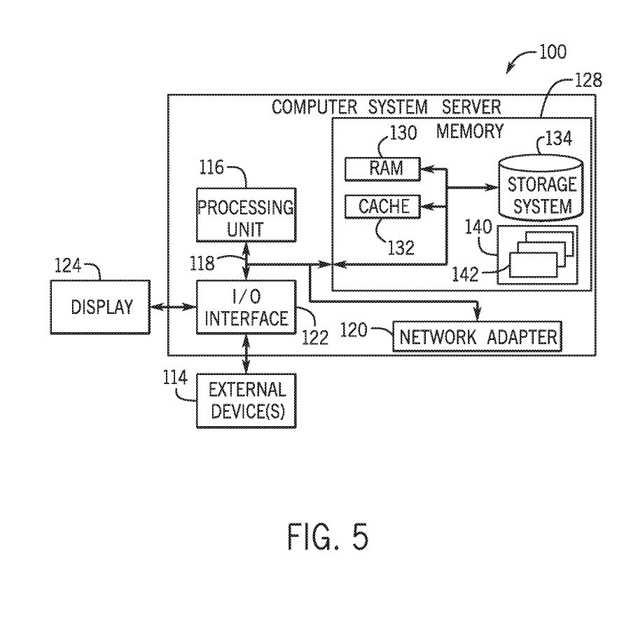

Referring now to FIG. 1 a method 10 for authenticating a user's identity through an electronic interface is shown according to an exemplary embodiment. FIGS. 3 and 4 show screenshots of exemplary user interfaces 300 and 400 representing registration and login processes respectively which may be viewed concurrently with FIG. 1 to illustrate the respective processes. To distinguish between process steps and physical elements, the process steps will be shown in parenthesis. As will be understood and described further below with respect to FIG. 5, steps described in the method 10 are generally performed by a processor unless indicated otherwise.

The method 10 may begin with determining (15) whether the user is initiating a registration process or a login process on an electronic platform. The following will describe the registration process first.

In block (20), the system receives user registration information. This may include for example as shown in FIG. 3, a first name entered in field 315, a last name in field 320, and an e-mail address in field 330 provided by entry into window 310. It will be understood that a user's account may use other information to associate the user with a password. For example, a fictitious username may be used instead of the first and last name. The system may receive (25) from user entry elements for a password. The password may be entered into field 330 and re-entered for confirmation of accuracy in field 335. In an exemplary embodiment, the password may be generated in whole or at least partly from an image file. For example, the user may open up (or the system may automatically open) a window where stored image files are kept locally on the user's computing device. As shown in FIG. 3, the window 350 is opened and provides access to image files stored in folder 360.

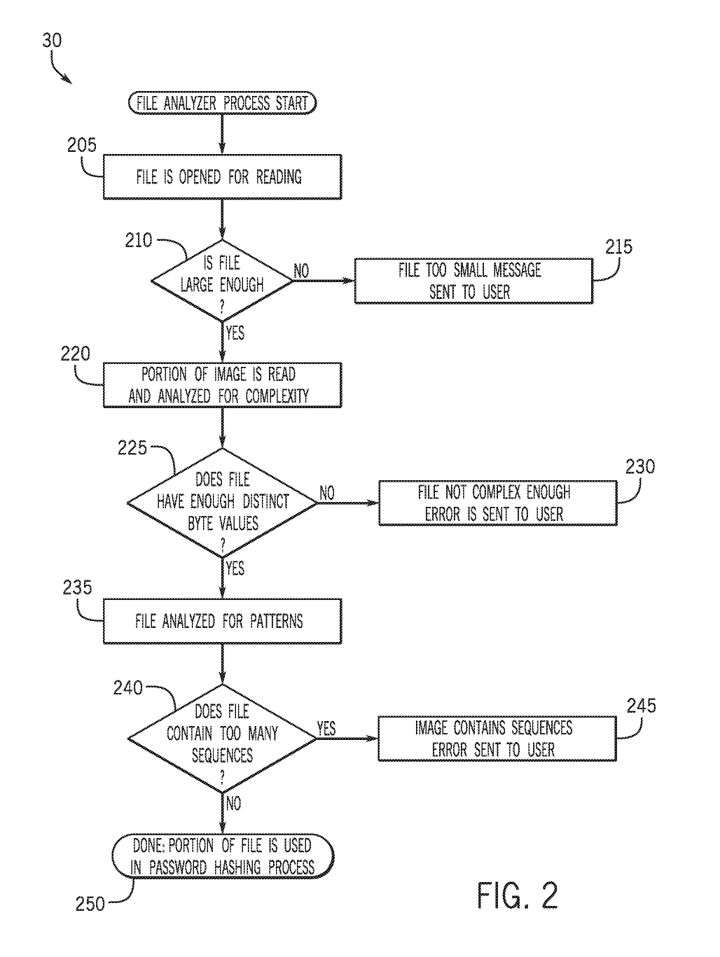

In some embodiments, the registered password may include data relating to the selected image file(s) and alphanumeric content. For example, the password entry shown is represented by dots (as is known in a technique to hide the entered elements from view). The dots numbered 340 and 345 may represent placeholder positions for the two separately selected image files. The remaining dots may represent placeholders for the alphanumeric content used for the password. During entry of the password, the user may select an image file from for example, folder 360 and the system may analyze (30) the selected image for use as a password element. Details of the image analysis step (30) are described in further detail with respect to FIG. 2.

The step (25) of receiving an entered alphanumeric character or a selected image file may repeat as necessary during the password entry phase until the password is complete. For selected images, the system may select (35) a predetermined number of bytes from the image for use in generating a value associated with the image file. The byte values may be from non-sequential portions of the image or from sequential sections of the image. In an exemplary embodiment, 600 bytes of the image file are used to manage the memory size of the password to a reasonable amount rather than require in some embodiments, the entire image which may present storage size challenges for a stored password. The hash may be generated as a combination based on the bytes in each image that is selected, so one hash may be generated as an amalgamation of all the images along with the password characters the user has entered. By selecting only parts of the image file, another layer of security is provided against cyber threats that are able to access the whole image file. As may be appreciated, cyber thieves are faced with the challenge of discerning which parts of an image are used to generate the hash value. The placeholders for the selected image file content data may be entered and displayed by the system in the password entry fields 330 and 335. Additional elements of the password are received including alphanumeric content and/or the second image file data represented by dot 345 which maybe generated for example by a different image file than the file represented by dot 340.

After each password element is entered, a determination (40) may be made as to whether the password registration is finished. Once finished, the system may calculate the password's hash value based on all the image files entered for the password and any alphanumeric password entries input. The registered password including the hash value for the password may be saved in association with the user account. In some embodiments, the account information and saved registered password are stored in a remote server (which in some embodiments is a cloud based system as described below with respect to FIG. 5). The method 10 may terminate (50) with successful registration.

The following describes an exemplary login phase of the method 10. The system may receive (55) account information identifying the user. For example, as shown in FIG. 4, the user may be presented the window 410 for receipt of the user identification in field 325. For illustrative purposes, the same identification used in FIG. 3 to illustrate the registration process is used again in FIG. 4 to identify the same user. The system may receive (60) from the user password elements that may include selected image files from the user's local storage in the computing device running the authentication interface. For example, as shown in FIG. 4, user inputs into field 430 the password elements used during the registration process. The password shown includes image file related data (represented again by placeholder dots 340 and 345) and may include alphanumeric content between the two image file parts of the password. The image file represented by dot 345 may be selected from a different location than the image file represented by dot 340. For example, in FIG. 4, the entry for the image file represented by dot 345 may be selected from the folder 460 from window 450 that is a different file storage location than that represented by window 350 in FIG. 3.

The system may analyze (65) the entered password elements for image file data similar to the process in step (30). For selected images entered into the password field 430, the system may select (70) a predetermined number of bytes from the image(s) in generating a value associated with the image file(s) for calculating the password hash value, which may be similar to the process used in step (35) during registration. In an exemplary embodiment, the bytes used may be consistent across images so that the bytes used during registration are the same bytes checked against during login. After each password element is entered, a determination (75) may be made as to whether the login password entry is finished. Once finished, the login password entry may be hashed (80) using the image file data (and any alphanumeric input) from the password entry. The generated hash may be scrambled to prevent patterns that may be identified by cyber thieves/malware. For example, the hash may be initially generated as an array of bytes, and then the bytes may be reordered, rearranging the bytes for different indices of the array so that a hacker may not be able to determine patterns in the hashing algorithm. The system retrieves (85) from storage, the user account information along with the stored password including the hash value(s) of the password. A determination (90) is made comparing the stored registration password to the login process password entry. For login password entries hash values that match the stored registration password hash value, access is authenticated 98. For password entries that do not match the registration password and hash values, the user is denied login access.

Referring now to FIG. 2, a process 30 of analyzing an image file for generating a hash value is shown according to an exemplary embodiment. The system may open (205) a user selected image file for reading. In some embodiments, image files need to meet a minimum size requirement to extract enough usable byte values. A determination 210 may be made whether the selected file is large enough. For files that are too small, a message may be sent 215 to the user indicating an error regarding usable file size. For usable files, a portion of the image is read (220) and may be analyzed for complexity. A determination (225) may be made on whether the image file has enough distinct byte values that can be used to generate a hash value. For example, foe embodiments assigning a value based on color, if the portions of the image mostly or all use pixels of the same color value, the image may be too homogenous to generate a secure hash value. For files that are not complex enough, an error message may be sent (230) to the user. For files with enough distinct values, the file(s) maybe analyzed (235) for patterns. In some embodiments, a determination (240) may be made as to whether the file includes too many sequences. For images including too many sequences above a threshold value of sequences, an error message (245) may be sent to the user. If the image file does not contain too many sequences, the portion of the image file analyzed may be used in the password hashing process described for example, in FIG. 1.

Referring now to FIG. 5, a schematic of an example of a computer system/server 100 is shown. The computer system/server 100 is shown in the form of a general-purpose computing device. The computer system/server 100 may serve the role as the machine implementing for example the functions of generating registration and login screens, generating hash values for user selected images, analyzing images for file size, complexity, and patterns/sequences, calculating hash values, storing password and user identification information in association with users, and determining successful/unsuccessful logins. The components of the computer system/server 100 may include, but are not limited to, one or more processors or processing units 116, a system memory 128, and a bus 118 that couples various system components including the system memory 128 to the processor 116.

The computer system/server 100 may perform functions as different machine types depending on the role in the system the function is related to. In some embodiments, the computer system/server 100 is the machine providing the user interface and storage of image files used for password. In some embodiments, the computer system/server 100 is a machine remote from the user and user interface hosting authentication services and storing registration information including the hash values generated during registration. For example, depending on the function being implemented at any given time when interfacing with the system, the computer system/server 100 may be for example, personal computer systems, tablet devices, smart mobile telephone devices, handheld or laptop devices, multiprocessor systems, microprocessor-based systems, set top boxes, programmable consumer electronics, network PCs, and distributed cloud computing environments that include any of the above systems or devices, and the like providing electronic platforms including authentication processes disclosed herein and electronic screens for user interface. In some embodiments, the computer system/server 100 is a server(s) computer system hosting the authentication process for use in third party sites.

In some embodiments, the computer system/server 100 may be a cloud computing node connected to a cloud computing network (not shown). The computer system/server 100 may be practiced in distributed cloud computing environments where tasks are performed by remote processing devices that are linked through a communications network. In a distributed cloud computing environment, program modules may be located in both local and remote computer system storage media including memory storage devices.

The computer system/server 100 may typically include a variety of computer system readable media. Such media could be chosen from any available media that is accessible by the computer system/server 100, including non-transitory, volatile and non-volatile media, removable and non-removable media. The system memory 128 could include random access memory (RAM) 130 and/or a cache memory 132. A storage system 134 can be provided for reading from and writing to a non-removable, non-volatile magnetic media device. The computer system/server 100 may be described in the general context of computer system executable instructions, such as program modules 142, being executed by the computer system/server 100. The system memory 128 may include at least one program product 140 having a set (e.g., at least one) of program modules 142 that are configured to carry out the functions of embodiments of the invention. The program modules 142 generally carry out the functions and/or methodologies of embodiments of the invention as described above.

The computer system/server 100 may also communicate with one or more external devices 114 such as a keyboard, a pointing device, a display 124, etc.; and/or any devices (e.g., network card, modem, etc.) that enable the computer system/server 100 to communicate with one or more other computing devices. Such communication can occur via Input/Output (I/O) interfaces 122. The display 124 may be configured to show the electronic user interfaces for account registration, password entry and file image selection.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 216 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for authenticating a user's identity through an electronic interface, the computer program product comprising a non-transitory computer readable storage medium having computer readable program code embodied therewith, the computer readable program code being configured to:
receive from a user entry into the electronic interface during a registration process, an image file selected by the user from a computing device storage module;
analyze a portion(s) of the image file for byte values representing the portion(s);
generate a hash value from the analyzed portion(s) of the image file, wherein the hash value represents at least a portion of a password;
store the generated hash value in association with a user's password registration including the password;
determine whether a user password input during a login process includes the stored generated hash value; and
authenticate or deny the login process based on the user password input including the stored generated hash value.

2. The computer program product of claim 1, wherein the image file used to generate the hash value is stored in a local computing device of the user.

3. The computer program product of claim 2, wherein the generated hash value is stored in a server located remotely from the local computing device of the user and the server performs the step of determining whether the user password input during the login process includes the stored generated hash value.

4. The computer program product of claim 2, wherein the user password input during the login process includes the user retrieving the image file from storage in the local computing device.

5. The computer program product of claim 1, wherein the password includes alphanumeric characters in addition to the generated hash value.

6. A server system comprises a processor configured to:
receive from a user during a login process, a password entry into an electronic interface, the password entry including an image file selected by the user from a local computing device storage module;
analyze the image file for byte values representing the image file;
determine a login hash value from the analyzed image file, wherein the login hash value represents at least a portion of the password entry;
retrieve from server storage, a stored hash value associated with a registered password provided by the user, the stored hash value based on an image file selected by the user during the registration process;
determine whether the password entry including the login hash value during the login process matches the registered password retrieved from server storage; and
authenticate or deny the login process based on the user password entry including the stored hash value based on the image file selected by the user during the registration process.

7. The server system of claim 6, wherein the registered password includes alphanumeric characters used in the password entry in addition to the stored hash value based on the image file selected by the user during the registration process.

8. The server system of claim 6, wherein the byte values represent non-sequential blocks of the image file selected by the user from the local computing device storage module.

9. The server system of claim 6, wherein the byte values represent at least some sequential blocks of the image file selected by the user from the local computing device storage module.

10. The server system of claim 6, wherein the stored hash value is based on a threshold number of distinct byte values.
